(19) United States
(12) Patent Application Publication
(10) Pub. No.: US 2024/0286907 A1
(43) Pub. Date: Aug. 29, 2024

(54) Conversion of Organic Material to Doped Nanocarbon Structures via Microwave Plasma Pyrolysis

(71) Applicant: Board of Regents, The University of Texas System, Austin, TX (US)

(72) Inventors: Benjamin Stein, Dallas, TX (US); Orlando Auciello, Garland, TX (US)

(21) Appl. No.: 18/590,318

(22) Filed: Feb. 28, 2024

Related U.S. Application Data
(60) Provisional application No. 63/487,455, filed on Feb. 28, 2023.

(51) Int. Cl. C01B 32/26; A01G 18/20; C01B 32/28; D01F 9/16; D06M 11/58; D06M 11/81; D06M 101/40; H01M 4/133; H01M 4/587; H01M 10/0525

(52) U.S. Cl. CPC C01B 32/26; C01B 32/28; D01F 9/16; D06M 11/58; D06M 11/81; H01M 4/133; H01M 4/587; H01M 10/0525; A01G 18/20; C01P 2002/54; C01P 2002/60; C01P 2006/40; D06M 2101/40; D10B 2505/00

(57) ABSTRACT

The present disclosure teaches a method of processing chitin, including providing a source of chitin; and pyrolyzing at least a portion of the source of chitin using a microwave plasma. Pyrolyzing includes producing a nanostructured carbon material including at least one of diamond, ultrananocrystalline diamond (UNCD), graphite, and graphene. Pyrolyzing also includes doping the nanostructured carbon material with at least one element selected from the group consisting of nitrogen and boron. Compositions of matter and articles of manufacture are also disclosed.

### CROSS-REFERENCE TO RELATED APPLICATION

Referring to the application data sheet filed herewith, this application claims a benefit of priority under 35 U.S.C. 119(e) from co-pending provisional patent application U.S. Ser. No. 63/487,455, filed Feb. 28, 2023, the entire contents of which are hereby expressly incorporated herein by reference for all purposes.

### GOVERNMENT SUPPORT

This invention was made with government support under Grant no. W911NF-20-2-0010 awarded by the Army Research Office. The government has certain rights in the invention.

### BACKGROUND

Fungi are one of the oldest branches of multi-cellular organisms on the planet and have played a variety of roles in human societies since pre-agricultural times. However, it took humanity reaching to the modern era to conduct studies of the Fungi's biochemical and medicinal attributes. In recent years, Fungi have begun to attract attention for alternative uses, such as binders in structural composites, due to their ability to colonize and adapt to nearly any type of biomass and environment. Manufacturing new products based on biological systems represents a paradigm shift in product lifecycles and environmental considerations as it allows for economic expansion without sacrificing ecological health or reliance on non-renewable resources. More recent studies demonstrated that fungal mycelium might be critical for space and interplanetary exploration and other exotic environments due to their unique adaptability and robustness in extreme environments such as Mars or highly radioactive zones like Chernobyl.

A small group of designers, artists and scientists have pioneered methods for growing and processing fungal root fibers (called mycelium) in forms that allow them to be utilized as textiles, for example, referring to FIG. 1, MycoFlex 110 which exhibits a texture and durability comparable to animal-derived leather, at a significantly reduced cost and time to market. A processing step common to all myco-products is a final heat treatment to “kill” or deactivate the organism, preventing further growth and reducing time to degradation via decomposition.

Heretofore, the requirement(s) of economic expansion without sacrificing ecological health or reliance on non-renewable resources and reduced cost and time to market referred to above have not been fully met. In view of the foregoing, there is a need in the art for a solution that simultaneously solves all of these problems.

### SUMMARY

There is a need for the following embodiments of the present disclosure. Of course, the present disclosure is not limited to these embodiments.

Embodiments of this disclosure relate to methods of transforming chitlin into doped ultrananocrystalline diamond through microwave plasma pyrolysis (MPP), and to compositions of matter and articles of manufacture composed thereof. In particular, embodiments relate to nitrogen doped ultrananocrystalline diamond (N-UNCD) and boron doped ultrananocrystalline diamond (B-UNCD) coatings derived from microwave plasma pyrolysis of fungal mycelium. For example, when relevant data measurements from N-UNCD coated on lithium ion battery Graphite/Cu anodes is compared to relevant data measurements from lithium ion battery Graphite/Cu anodes without N-UNCD coating, superior performance of the lithium ion batteries with the N-UNCD-coated Graphite/Cu anodes is shown.

According to an embodiment of the present disclosure, a method of processing biomaterial, comprising: providing a source of chitin; and pyrolyzing at least a portion of the source of chitin using a microwave plasma, wherein pyrolyzing comprises producing a nanostructured carbon material comprising at least one of diamond, ultrananocrystalline diamond, graphite, and graphene and doping the nanostructured carbon material with at least one element selected from the group consisting of nitrogen and boron.

According to another embodiment of the present disclosure, a composition of matter comprises: a nanostructured carbon material comprising a network of fibers, the network of fibers being arranged in a branching root configuration, wherein the network of fibers are comprised of at least 90% by weight of nanocarbons comprised of diamond, ultrananocrystalline diamond, graphite, graphene, and combinations thereof and wherein the nanostructured carbon material comprises at least one dopant element selected from the group consisting of nitrogen and boron.

According to another embodiment of the present disclosure, an article of manufacture comprises: a nanostructured carbon material body comprising a network of fibers, the network of fibers being arranged in a branching root configuration, wherein the network of fibers are comprised of at least 90% by weight of nanocarbons comprised of diamond, ultrananocrystalline diamond, graphite, graphene, and combinations thereof and wherein the nanostructured carbon material comprises at least one dopant element selected from the group consisting of nitrogen and boron.

These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings:

FIG. 1 illustrates a sample of Ecovative Mycoflex, appropriately labeled “prior art.”

FIG. 2 illustrates an integrated glass-tube/microwave oven for pyrolytic plasma process to transform mycelium into UNCD.

FIGS. 3a-3d illustrate 3a) “Myco-leather” grown on liquid medium, and 3b) a small piece after soaking in glycerol (top); 3c) and 3d) SEM images of a treated sample showing distinctly different morphologies (bottom).

FIG. 4 illustrates a microwave plasma used for plasma pyrolysis of mycelium grown by liquid medium (picture shows through a window in the door a glass-tube containing a bright Argon gas-based plasma pyrolyzing a mycelium fabric).

FIGS. 5a-5b illustrate optical pictures of Mycelium Ecovative composite sample a) before pyrolysis, and b) a small piece after Ar gas based plasma pyrolysis (right-notice the color turned to black, characteristic of carbon based material).

FIGS. 6a-6c illustrate an example of UNCD film grown by microwave plasma chemical vapor deposition (MPCVD) on a Si substrate, a) photograph; b) Raman spectrum showing Raman peaks characteristic of UNCD films; c) high resolution transmission electron microcopy (HRTEM) image of the UNCD film grown by microwave plasma chemical vapor deposition (MPCVD) on the Si substrate. (The Raman spectrum 6b and the HRTEM image of the UNCD film 6c match the Raman spectrum and HRTEM image of UNCD film produced by plasma pyrolysis transformation of mycelium onto UNCD material (see FIGS. 7a and 7c).

FIGS. 7a-7c illustrate a) Raman spectrum of mycelium transformed UNCD 510 shown in FIG. 5b this Raman spectrum is matches the Raman spectrum of the UNCD film grown by MPCVD (see FIG. 6b); b) X-ray diffraction on the same mycelium transformed UNCD material for which the Raman spectrum is shown in a) (The three XRD peaks are the characteristic peaks of diamond, confirming the Raman analysis); c) HRTEM taken on a piece of mycelium transformed UNCD, as shown in FIG. 5 (b) (The HRTEM image confirms that the transformed material is indeed UNCD with the 3-5 nm grains size characteristic of UNCD, and the insert electron diffraction pattern on top right confirms that the UNCD is diamond).

FIGS. 8a-8d illustrate a) and b) SEM images of mycelium after plasma exposure, showing nanoscale features; c) and d) TEM images of plasma processed mycelium showing UNCD “fingers” (and the insert electron diffraction pattern on bottom right shows electron diffraction pattern corresponding to diamond).

FIGS. 9a-9f illustrate a) SEM image of electrically conductive N-UNCD coating grown on Graphite/Cu anode of Li-ion battery; b) Raman analysis showing the characteristic spectrum of N-UNCD coating; c) schematic of Li-ion battery fabricated with N-UNCD coated Graphite/Cu anode; d) Voltage vs time for first discharge of Li-ion batteries with N-UNCD/G/Cu anode and commercial G/Cu anode (notice the superior first discharge constant current for the Li-ion battery with the N-UNCD/G/Cu anode; e) Capacity density vs. charge/discharge cycles for Li-ion batteries with N-UNCD/G/Cu and commercial G/Cu anodes, showing the far superior performance of the Li-ion batteries with N-UNCD/G/Cu exhibiting stable Capacity Density up to 1,200 c/d cycles, while the Li-ion battery with the commercial G/Cu anode exhibits substantial degradation in Capacity Density; f) X-ray diffraction (XRD) of N-UNCD/G/Cu and G/Cu anodes before and after measurement of Capacity Density vs. Charge/Discharge cycles, showing the Li induced degradation for the G/Cu anode (red spectrum), via formation of LiC6, LiC12 and LiC24, taken after capacity measurements, while the XRD spectra of the N-UNCD-coated G/Cu anode show identical spectra, indicating NO lithium-induced degradation of the N-UNCD coating.

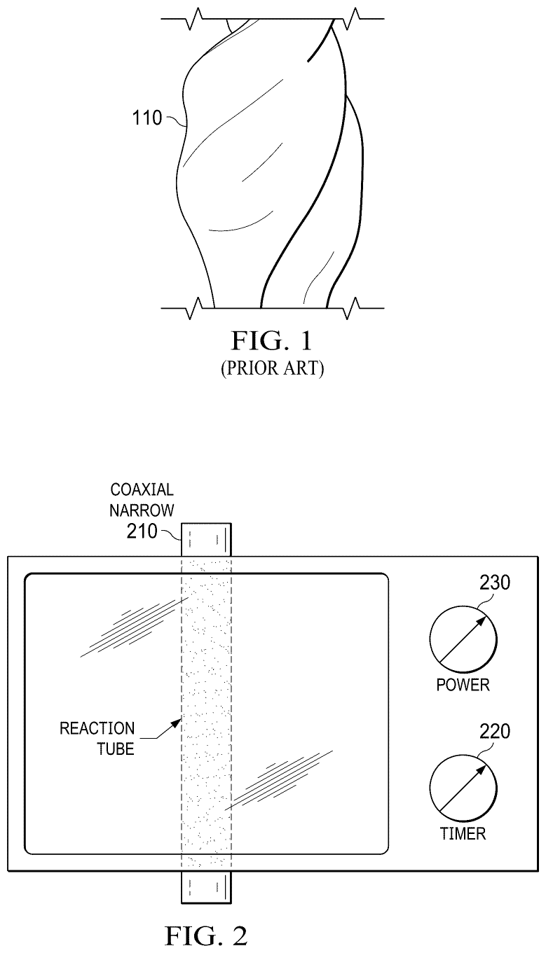

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

The disclosure of this application is technically related to co-pending U.S. Ser. No. ______ (attorney docket number UTD21017US1), filed Feb. 28, 2024, the entire contents of which are hereby expressly incorporated by reference for all purposes.

This invention relates to a technology that applies complementary processes to produce a revolutionary transformation of “fungal bio-mycelium” into ultrananocrystalline diamond (UNCD) in various materials forms, such as particles with micro to nano dimensions, porous UNCD structured material, and UNCD films (coatings) with grain sizes in the range 3-10 nm, all of them with the unique mechanical, chemical, tribological (low friction) properties of diamond, and with chemical tailoring of electronic properties (semiconductor to electrical fully conductor) via insertion of dopant atoms (e.g., nitrogen (N) and boron (B) atoms), with N atoms inserted into grain boundaries, for doping, and B atoms replacing C atoms in the lattice of the crystalline nanoscale grains of UNCD, for doping. In particular, this invention teaches methods to insert the mycelium transformed UNCD material on different platform materials to produce key components of transformational electronic-based devices and external and implantable medical devices/prostheses, namely:

Embodiments of this disclosure include nanostructured flexible UNCD-based material enabling new generation of masks with ≤10 nm pores, for superior protection against transmission of viruses like COVID-19 (60-140 nm diameter), which is not properly stopped by current medical and public masks, with pores in the range 10 to 100s of microns, as shown by detailed electron emission microscopy analysis.

Embodiments of this disclosure include electrically conductive Nitrogen or Boron atoms-doped UNCD-based electrodes of Li-ion batteries (LIBs), providing orders of magnitude superior capacity energy and safety than electrodes in current LIBs, induced by the unique resistance of UNCD to chemical attack by Li ions.

Embodiments include mycelium transformed into biocompatible UNCD coating to protect the surface of current metal based implantable medical devices and prostheses from chemical attack by body fluids, thus enabling the production of new generations of implantable medical devices/prostheses with orders of magnitude longer life when implanted in the human body.

Embodiments include nanostructured or Fibrous UNCD material with unique biological/biocompatible properties, for production of novel scaffolds to grow embryonic stem cells and induce differentiation into other human cells, for application to developmental biology, replacing degenerated natural human cells, to treat conditions such as Parkinson's decease, blindness due to genetically-induced degeneration of photoreceptors, and many other biological conditions induced by biological degeneration of natural human cells. While the processing step common to all myco-products is a heat treatment to “kill” or deactivate the organism, preventing further growth and reducing time to degradation via decomposition, a mask or filter composed of mycelium may require further modification or enhancements to ensure filtration efficacy and durability after sanitization.

Methods are described involving complementary processes to produce a revolutionary transformation of “fungal bio-mycelium” into ultrananocrystalline diamond (UNCD) material in various forms, such as particles with micro to nano dimensions, porous UNCD structured material, and UNCD films (coatings) with grain sizes in the range 3-10 nm, all of them with the unique mechanical, chemical, tribological (low friction) properties of diamond, and with chemical tailoring of electronic properties (semiconductor to electrical fully conductor) via insertion of dopant atoms (e.g., nitrogen (N) or boron (B) atoms), with N atoms inserted into grain boundaries, for doping, and B atoms replacing C atoms in the lattice of the crystalline nanoscale grains of UNCD, for doping.

In particular, the disclosure teaches methods to insert the mycelium transformed UNCD material on different platform materials to produce key products. Embodiments include transformational masks for protection against transmission of COVID-19 and other viruses, bacteria, and any other pathogen, order of magnitude more efficient than current masks (with large ≥20 micron pores), due to UNCD coating with pores of ≤20 nm.

Embodiments include N-UNCD or B-UNCD coating on the surface of electrodes for Li-ion batteries, providing protection against Li-ions induced corrosion of graphite/copper or silicon-based anodes and multicomponent oxide cathodes, resulting in orders of magnitude longer capacity energy vs. charge/discharge cycles, and safer, due to N-UNCD or B-UNCD coating elimination of SEI layers, which cause overheating and potential explosion in current Li-ion batteries.

Embodiments include mycelium transformed into biocompatible UNCD coating to protect the surface of current metal based implantable medical devices and prostheses from chemical attack by body fluids, thus enabling the production of new generations of implantable medical devices/prostheses with orders of magnitude longer life when implanted in the human body.

Embodiments include nanostructured or fibrous UNCD material with unique biological/biocompatible properties, for production of novel scaffolds to grow embryonic stem cells and induce differentiation into other human cells, for application to developmental biology, replacing degenerated natural human cells, to treat conditions such as Parkinson's decease, blindness due to genetically-induced degeneration of photoreceptors, and many other biological conditions induced by biological degeneration of natural human cells.

Embodiments of the novel processes described in this patent transform the mycelium into a nanocarbon material via exposure of the mycelium to a low cost ionized gas or plasma, to induce either total or partial pyrolytic carbonization. Processing of materials via exposure to plasmas is an integral part of numerous industries, most notably semiconductor manufacturing, and has generated interest in various other industries, including garment and textile production. Plasma pyrolysis of biomass was initially focused on gasification and waste management, although numerous researchers have found that treatment of bast or hemp fibers by plasmas can yield useful nanocarbons, or as a preliminary processing step. Compared to conventional thermal pyrolysis, plasma pyrolysis is significantly faster, more energy efficient, and flexible, allowing for better adoption into a full production process.

Biologically driven manufacturing represents a fascinating and potentially critical new industrial paradigm capable of meeting a growing global demand for essential products without deleterious environmental harm. The processes presented in this disclosure provide new manufacturing and biomaterials processing methodology capable of enabling a new kind of “circular” economy that is both environmentally and economically sustainable.

The first key application of the transformational Fungal Bio-Mycelium into ultrananocrystalline diamond (UNCD) is focused on the production of a “myco-mask” based on growing the mycelium in a form which can function as a viral particulate filter, either as a facemask or as a replacement filter in a separate system. The key property of a “myco-mask” is the filtration efficiency, which is determined by average pore size and the ability to capture a particle of approximate dimensions as a COVID-19 virus I—described by the CDC as the most penetrating particle size in the range of 60-120 nm. This is a critical process, as a filtration membrane needs to allow airflow in the range of 10 cm/s, determined by the CDC, as the nominal breathing rate of a healthy adult at rest, while still performing as a particle filter. Secondary properties like durability, thickness, and flexibility are critical for a facemask or mechanical filter. The demonstrated diamond properties of UNCD exceed current materials properties of every material used for fabrication of masks.

The pyrolysis process produces complete conversion of all biomass into a pure carbon form while still retaining or improving its mechanical integrity and porosity. A fully carbonized mask material allows for easier sanitization without degradation using conventional methods, increasing the reusability of the final product and helping to eliminate waste and future material shortages. However, if test protocols underway provide information revealing that a non-pyrolyzed mask performs efficiently, then it can be considered as a separate product intended for public consumption, while the fully pyrolyzed mask is applied for professional usage as it will necessarily be more expensive. Parameters determining fungal growth rates and hyphal dimensions (a hyphae are an individual strand of mycelium), largely dependent on the species being utilized and its source/type of nutrition, as well as ambient temperature and humidity are considered for optimization of the conversion of all biomass into a pure nanocarbon form.

The fundamental and applied scientific and technology development information presented above shows that transformation of “fungal bio-mycelium” into ultrananocrystalline diamond (UNCD), in various materials forms, provides a new paradigm nanocarbon-based material enabling s new generation of high-tech, medical, and public use devices and products. The transformation is produced via a plasma pyrolysis process using a novel flow of inert gas Argon mixed with atmospheric gasses to induce the transformation.

Embodiment include growth of mycelium on woven fabric. The simplest and most straightforward process for preparing a mycelium-based fabric for facemask and other products is based on starting with an existing fabric and then cultivate a mycelium “skin” on its surface, followed by plasma pyrolysis. This requires the fabric material to be both compatible with mycelial colonization as well as the final plasma pyrolysis conversion step. While fungal mycelium has been shown to be capable of colonizing a very wide variety of biological materials, this process is based on hemp as the primary fabric-based substrate for its robustness, cost to manufacture, and prior unpublished work performed demonstrating that hemp fibers can be converted into carbon nanomaterials very quickly with plasma pyrolysis. Prior work in the literature and mushroom industry has shown that mycelium can colonize hemp quite easily, increasing its viability as an ideal substrate candidate. As with all processes, already described in the literature, the process described in this section involves selecting the ideal fungal species, growth conditions and nutritional mix, as well as determining appropriate fabric weaves and blends based on fabric samples from a supplier. From a manufacturing point of view, this process requires the least amount of processing and handling since hemp-based fabric masks can be assembled and shipped directly from any fabric supplier with the mycelial functionalization and pyrolysis being considered a value-added step. Sterilization of the substrate is a crucial step prior to fungal colonization. In this sense, three main approaches to fabric sterilization have been identified, namely: 1) exposure to UV light in the 250-350 nm range, 2) exposure to ozone (O₃) either in gaseous form or dissolved in water, and 3) autoclaving.

Embodiments include growth of mycelium in a composite. The second process to grow a mycelium-based fabric is to produce a slurry or powder, and then form it into a fabric with mask or other shape and allow the organism to grow and solidify like a composite. This technique was pioneered by the company Ecovative, which provides GIY (Grow-it-yourself) kits for purchase, along with molds in several basic shapes. However, the kits and molds provided by Ecovative are designed for very crude and simple shape forms, and the growth medium is a very coarse hemp hard mix. Adapting the Ecovative technique for this research will require a much finer growth medium like sawdust or lignin powder, and a customized or 3D printed mold for injection. While this technique has tremendous potential for further commercialization in other areas, there are a few issues, which will need to be addressed first besides the general issues related to contamination and sanitization of the mold material itself. Mycelium colonization is a biological process in which gasses and moisture are exchanged with the ambient environment. Any 3D printed mold material will need to be porous enough to allow for moisture and gaseous exchange while still providing a barrier to prevent the mycelium from growing through it.

Embodiments include growth of mycelium on a liquid substrate, aka “mushroom leather.” The third process to grow mycelium is based upon developing commercial efforts to develop Vegan Leather, wherein the mycelium is grown entirely on a liquid substrate as a floating mat, and then removed and treated to produce the desired material properties. This approach has unique limitations but is more likely to produce the purest mycelial-based filtration material with the best overall filtration properties. This approach also introduces unique challenges in determining how best to process the grown mycelial mat, as well as the composition of the liquid medium used which can determine the mycelial growth rate, density, and wall thickness.

Embodiments include microwave plasma pyrolysis. FIG. 2 shows a low-cost system to produce the plasma pyrolysis process to transform fungal mycelium into UNCD, using a standard commercial microwave oven as the magnetron and power control setup, with a standard roughing pump (not shown) and a coaxial narrow quartz furnace tube 210 to provide the vacuum environment for subsequent Argon gas flow to produce the plasma pyrolysis process for transformation of fungal mycelium into UNCD. There are numerous setups utilizing microwave ovens as plasma reactors. The system shown in FIG. 2 is capable of plasma processing temperatures ≥1000° C. in less than a minute and cooling down equally quickly. Gas flow control is provided via an inline regulator and flow valve. Time control 220 and power control 230 is adjusted via the integrated microwave control panel. The main advantages of this type of system are its low cost and low complexity, simplicity of operation, and robustness. A unique benefit of using a microwave oven is the elimination of the need for waveguides, power supplies, and matching networks used in producing a stable plasma, as the inner volume and wall geometry of the chamber is already designed to (mostly) uniformly heat food and thus functions perfectly well for plasma generation. Control over plasma power is easily achieved by adjusting the built-in microwave power settings on the control panel. Timing control is a uniquely useful feature for producing the pyrolysis process, as it allows the vacuum pump to remove evolving gaseous byproducts and prevent overwhelming and quenching the plasma. Additional components (not shown) to be added include a mass flow controller for digitized control of several gas lines, a mass spectrometer for chemical analysis of gaseous byproducts as a function of time and plasma temperature, and thermal infrared imaging or a similar temperature measurement device for accurate recording of plasma temperature as a function of time and vertical location within the column. These tools can be operated individually or linked together using a computer or Arduino control module to allow for more accurate data logging and recipe management for greater process control and repeatability. For safety and simplicity, the process gas used is Argon (less expensive inert gas and no expensive safety cabinets required), which is commonly utilized as an effective carrier gas in most plasma systems. Addition of other gasses like methane and nitrogen allow for further functionalization of the resulting pyrolyzed products, including transformation of mycelium to nitrogen-doped UNCD (N-UNCD), which is electrically conductive and resistant to chemical corrosion, to be used for production of transformational Li-ion batteries electrodes, with eliminated Li-induced degradation, to enable a new generation of Li-ion batteries (LIBs) with ≥10× longer charge/discharge life and safer than current LIBs in the market, and for mycelium transformed into electrically conductive N-UNCD for masks trapping viruses, like COVID-19, orders of magnitude more efficiently than current masks. Alternatively, the argon can be replaced with nitrogen or other gases.

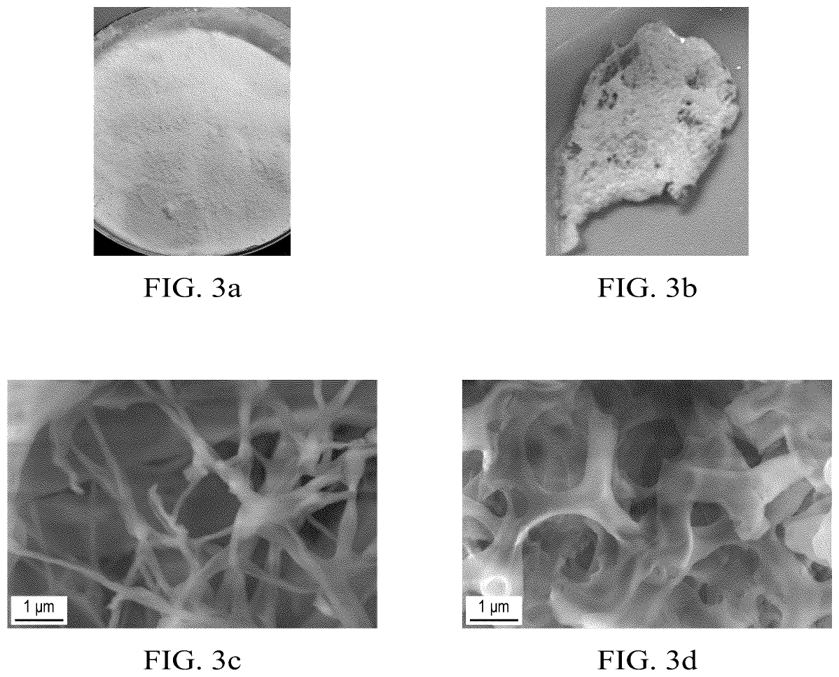

Embodiments include mycelium growth via liquid medium. Several liquid medium compositions were tested. The simplest liquid medium, composed of malt extract, glucose, water, and bacterial cultivation broth showed the fastest mycelium growth, developing a thin but solid mat covering the entire available surface. A piece was removed and soaked in glycerol for several days, to soften and “plasticize” the mycelium fibers, comparable to the leather tanning process. Once treated, the sample proved to be flexible and capable of handling gentle manipulation and did not dry out or deteriorate when left uncovered for several days. SEM analysis shown in FIGS. 3c-3d reveals a similar morphology for mycelium cultivated on the fabric substrates, indicating that the organism's nutritional source and composition may be more important than the substrate in determining how the mycelium grow and shape themselves.

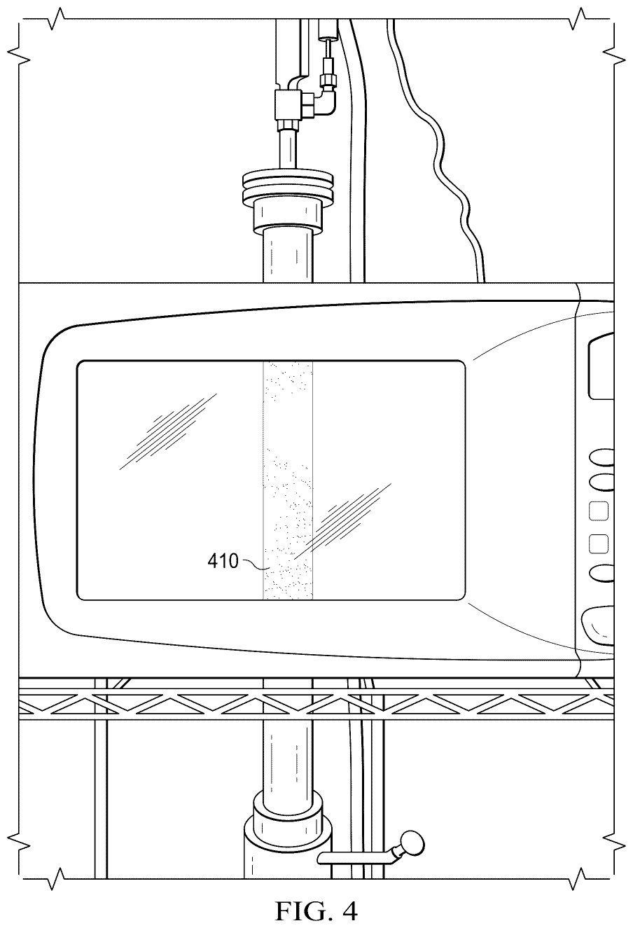

Embodiments include mycelium, grown via liquid medium, transformed into ultrananocrystalline diamond (UNCD) via microwave plasma pyrolysis. The quartz tube in the plasma pyrolysis system is evacuated to a pressure <1 Torr. Once the working pressure is reached, the microwave system is operated by inserting a desired time in the keypad. Referring to FIG. 4, the magnetron is then activated, and the resulting microwaves produce a stable bright plasma 410 inside the quartz tube, surrounding the mycelium fabric located on a solid holder. The plasma is produced by microwave power giving energy to molecules and atoms in the mycelium, which crack the chemical bonds of carbon (C) atoms with atoms like H, N and others, enabling C atoms to react chemically to other C atoms forming the sp³ chemical bonds between C atoms, characteristic of diamond.

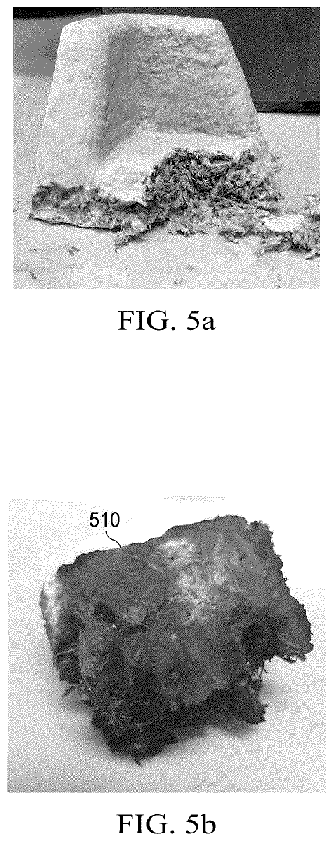

Optical pictures of the mycelium before and after plasma pyrolysis, shows that while the mycelium does not seem to change overall dimensions, it does undergo a change in color from clear (FIG. 5 (a) to s dark color characteristic of carbon (FIG. 5 (b)).

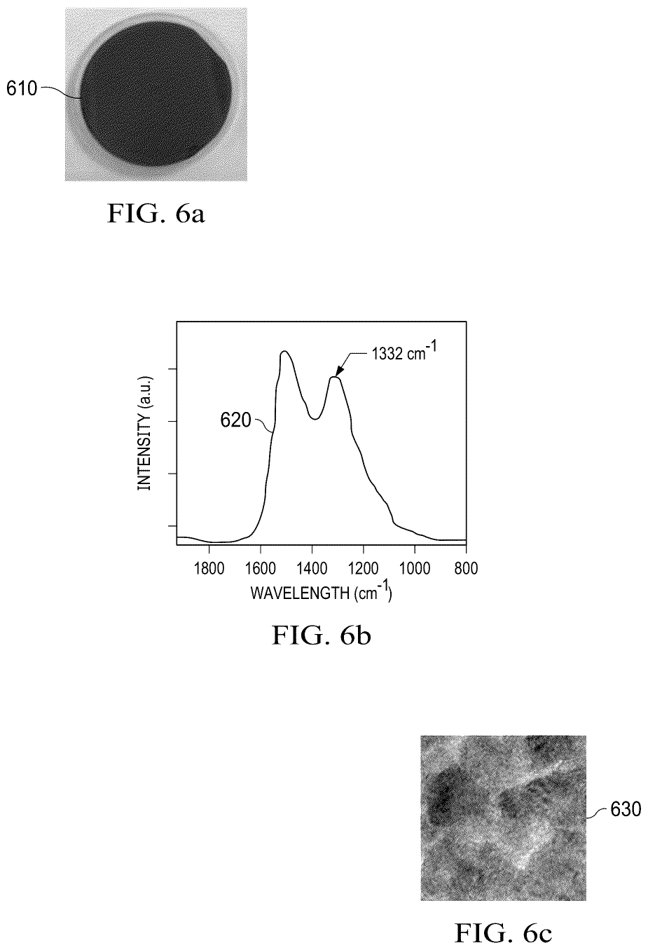

FIGS. 6a-6c are shown to provide key information that supports the experimental evidence that mycelium is transformed into UNCD by the microwave plasma pyrolysis process. FIG. 6a shows a large area UNCD coating 610 grown on a silicon wafer. FIG. 6b shows the Raman spectrum 620 of the UNCD coating, revealing the characteristic Raman spectrum of UNCD, confirmed by 1000s of experiments worldwide, published in the open literature on UNCD coating technology. FIG. 6c shows a high-resolution transmission electron microscopy (HRTEM) image 630 of the UNCD film characterized by the Raman spectrum in FIG. 6b; the HRTEM image shows the characteristic nanostructure of UNCD with grain sizes in the range 3-5 nm.

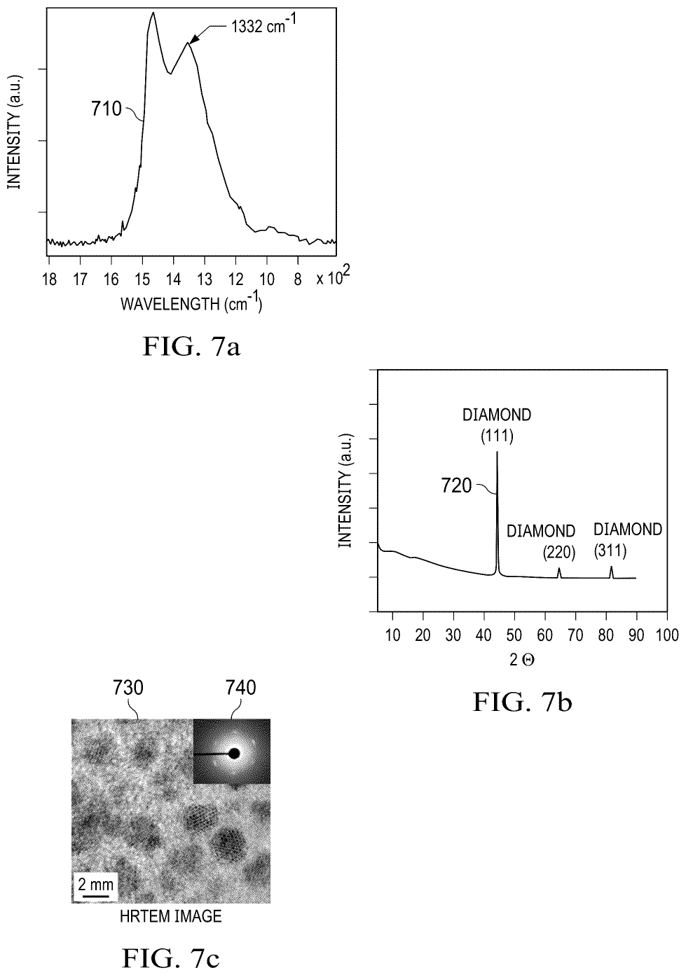

FIGS. 7a-7c show a Raman spectrum 710 from Raman analysis of the mycelium transformed in UNCD, shown in FIG. 5b (The Ramana spectrum in FIG. 7a is identical to the Raman spectrum of UNCD film grown on a silicon wafer, shown in FIG. 6b). FIG. 7b shows an X-ray diffraction spectrum 720 from the same mycelium transformed into UNCD, whose Raman spectrum is shown in FIG. 7 (a) (The XRD spectrum shows the three key peaks corresponding to diamond (111), (220), and (311) crystalline lattices. FIG. 7c shows a HRTEM image 730 of the mycelium transformed in UNCD, confirming the UNCD structure with 3-5 nm grain sizes and that is diamond, as revealed by the electron diffraction pattern 740 shown in the top right inset figure. In conclusion, FIGS. 7a-7c show that the mycelium has been transformed into UNCD.

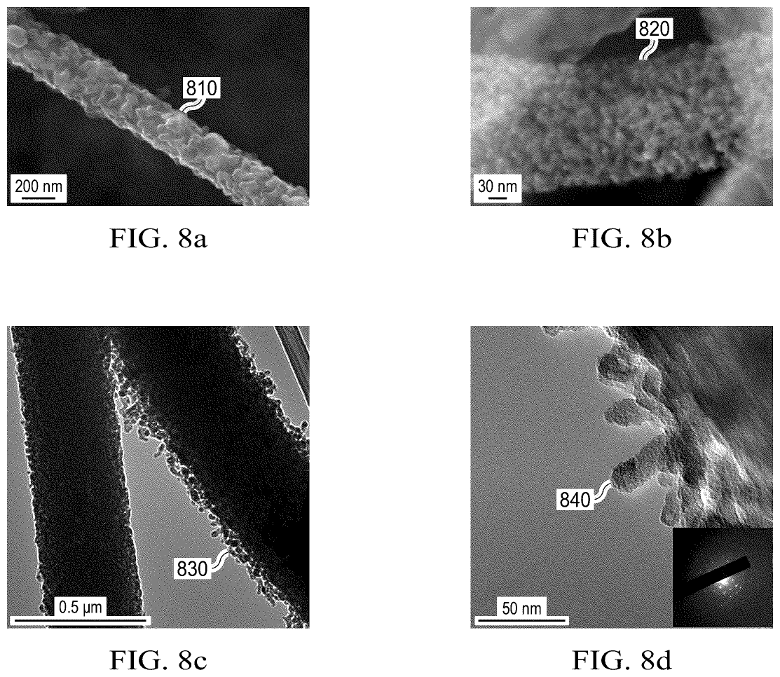

FIGS. 8a-8d show that microwave plasma pyrolysis can produce nanoscale surface features 810, 820 in the UNCD material FIGS. 8a-8b. In addition, low resolution FIG. 8c and high resolution FIG. 8d TEM images show that the plasma hydrolyzation process can also induce UNCD “fingers” formation 830, 840, which may be very useful for the intended particle filtration application for UNCD layer on medical and public masks, especially for the case of COVID-19 virus, which exhibits a unique circular geometry with 60-140 nm diameter. The UNCD fingers formation may also be very useful for battery cathode applications especially when the UNCD is doped with at least one of nitrogen or boron.

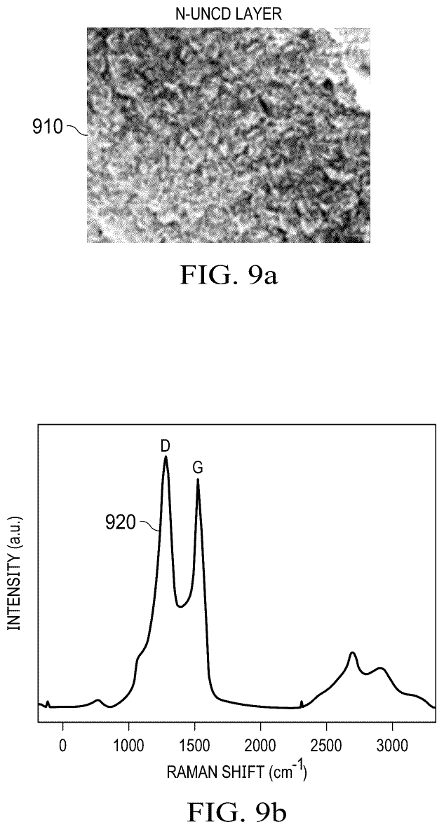

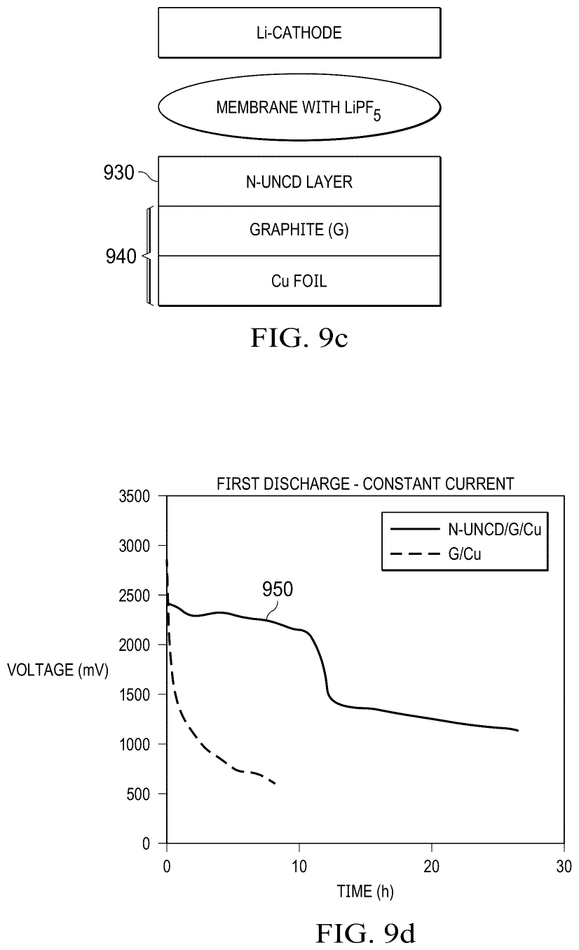

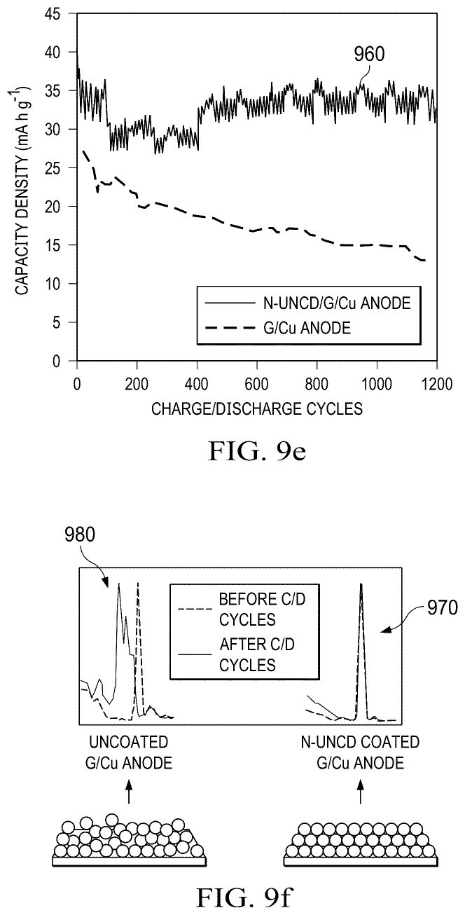

FIG. 9 shows key complementary information on the coating of commercial G/Cu anodes with the unique N-UNCD coating, with the complementary information provided by: a) SEM image of electrically conductive N-UNCD coating 910 grown on Graphite/Cu anode of Li-ion battery; b) Raman analysis showing the characteristic spectrum of N-UNCD coating 920; c) schematic of Li-ion battery fabricated with N-UNCD coated 930 Graphite/Cu anode 940; d) Voltage vs time for first discharge of Li-ion batteries with N-UNCD/G/Cu anode 950 and commercial G/Cu anode (notice the superior first discharge constant current for the Li-ion battery with the N-UNCD/G/Cu anode); e) Capacity density vs. charge/discharge cycles for Li-ion batteries with N-UNCD/G/Cu 960 and commercial G/Cu anodes, showing the far superior performance of the Li-ion batteries with N-UNCD/G/Cu exhibiting stable Capacity density up to 1,200 c/d cycles, while the Li-ion battery with the commercial G/Cu anode exhibit substantial degradation in Capacity Density; f) X-ray diffraction (XRD) of N-UNCD/G/Cu 970 and G/Cu anodes before and after measurement of Capacity Density vs. Charge/Discharge cycles, showing the Li induced degradation for the G/Cu anode 980 (upper left trace of the left hand spectrum), via formation of LiC6, LiC12 and LiC24, taken after capacity measurements, while the XRD spectra of the N-UNCD-coated G/Cu anode show identical spectra, indicating NO li-induced degradation of the N-UNCD coating.

Complementary processes are used to produce a revolutionary transformation of “fungal bio-mycelium” into ultrananocrystalline diamond (UNCD) in various materials forms. UNCD materials forms produced by transformation of mycelium into UNCD include: 1) particles with micro to nano dimensions, 2) porous UNCD structured material, 3) UNCD films (coatings) with grain sizes in the range 3-10 nm.

UNCD materials in the forms described above exhibit combination of exceptional unique mechanical, chemical, tribological (low friction) properties of diamond, and with chemical tailoring of electronic properties (semiconductor to electrical fully conductor), via insertion of dopant atoms (e.g., nitrogen (N) and boron (B) atoms), with N atoms inserted into grain boundaries, for doping, and B atoms replacing C atoms in the lattice of the crystalline nanoscale grans of UNCD, for doping.

In particular, this invention teaches methods to insert the mycelium transformed UNCD material on different platform materials to produce key components of transformational electronic-based devices and external and implantable medical devices/prostheses, namely: electrically conductive Nitrogen and Boron-doped N-UNCD and B-UNCD-based electrodes of Li-ion batteries (LIBs), providing orders of magnitude superior capacity energy and safety than electrodes in current LIBs, induced by the unique resistance of the N-UNCD and B-UNCD coatings to chemical attack by Li ions.

Nanostructured flexible UNCD-based material enabling new generation of masks with ≤10 nm pores, for superior protection against transmission of viruses like COVID-19 (60-140 nm diameter), which is not properly stopped by current medical and public masks, with pores in the range 10 to 100 s of microns, as shown by detailed electron emission microscopy analysis.

Fibrous UNCD material with unique biological/biocompatible properties, for novel scaffolds to grow embryonic stem cells and induce differentiation into other human cells, for application to developmental biology, replacing degenerated natural human cells, to treat conditions such as Parkinson's decease, blindness due to genetically induced degeneration of photoreceptors, and many other biological conditions induced by biological degeneration of natural human cells.

UNCD coating, with ≤30 nanometer (30×10⁻⁹ meter) pores, on the surface of current anti-virus masks, to stop viruses and other pathogens, order of magnitude more efficiently than current masks, with ≥20 micrometer (20×10⁻³ meter) pores, which are not stopping the COVID-19 virus (60-140 nm diameter), thus probable being responsible for 100s of nurses/medical doctors dead, reported worldwide, after attending patients, using masks.

### CLAUSES

1. Growth of mycelium “skin” on surface of fabrics for masks, electrodes for Li-ion batteries, surfaces of metal implantable medical devices/prostheses, via cultivation mycelium “skin” on surfaces described above.

2. Production of slurry or powder via crumbing of mycelium “skin”, followed by spreading on a flat surface of holder for subsequent solidification as a composite layer.

3. Growth of mycelium on a liquid substrate, as a floating mat, followed by removal to produce the purest mycelium-based porous material.

4. Exposure of the mycelium-based layer to a plasma created by microwave power coupling to Ar gas flown in a glass tube containing mixture of Nitrogen, Oxygen, and other atmospheric molecules in gas form. The Plasma processing temperature is in the range 800-1000° C. The plasma processing time is in the range 20-60 seconds.

5. Transformation of carbon atoms-based fungal mycelium into ultrananocrystalline diamond (UNCD) material in different forms (e.g., porous layers, thin film, fiber-based layer), with diamond-like properties (e.g., hardness of ˜100 GPa, Young modulus of ˜1000 GPa, friction coefficient of ˜ 0.02-0.04, extremely high resistance to chemical attack by any chemicals, and outstanding biocompatibility, based on being made of Carbon atoms (element of life in the human DNA, cells, and molecules). This is the key claim for this patent.

6. The methods of claims 1-5 wherein the mycelium transformed into UNCD film is selected as a UNCD coating put on the top surfaces of medical and public masks for superior efficient protection against virus, bacteria, and any other pathogen transmission, due to the nanometer pores of the UNCD coating vs current micrometer pores of current masks.

7. Clauses 1-5 wherein the mycelium transformed into UNCD film is doped by incorporating nitrogen (N) atoms in the grain boundaries, via N-based plasma producing N⁺ ions accelerated toward the UNCD film, via electric fields, to insert N atoms in the grain boundaries, reacting with dangling bond of C atoms, providing electrons for electrical conduction through grain boundaries of UNCD films.

8. Clauses 1-5 wherein the mycelium transformed into UNCD film is doped by incorporating Boron (B) atoms, replacing C atoms in the diamond lattice of UNCD films, and providing electrons to the conduction band to induce electrical conductivity of the UNCD films. The doping of B atoms is produced via spreading of a B-based layer on the surface of the UNCD film, followed by a rapid thermal annealing process, which insert B atoms into the diamond lattice of the UNCD films.

9. Clauses 1-5 and 7, producing electrically conductive N-UNCD films for coting electrodes (anodes and cathodes) of Li-ion batteries (LIBs).

10. Clauses 1-5 and 8, producing electrically conductive B-UNCD films for coting electrodes (anodes and cathodes) of Li-ion batteries (LIBs).

11. Clauses 1-5 and 7-8 to produce N-UNCD or B-UNCD coating on the surface of electrodes for Li-ion batteries, providing protection against Li-ions induced corrosion of graphite/copper or silicon-based anodes and multicomponent oxide cathodes, resulting in orders of magnitude longer capacity energy vs. charge/discharge cycles, and safer, due to N-UNCD or B-UNCD coating elimination of SEI layers, which cause overheating and potential explosion in current Li-ion batteries.

12. Clauses 1-5 wherein the mycelium transformed into UNCD film is incorporated on the surface of prostheses (e.g., dental implants, hips, knees and any other metal-based prosthesis) to protect them from failure due to corrosion by body fluids.

13. Clauses 1-5 wherein the mycelium transformed into UNCD film provides the coating with the best biocompatibility to put inside the human body, due to UNCD being made of C atoms (element of life in the human DNA, molecules, and cells).

14. Clauses 1-5 wherein the mycelium transformed into UNCD film provides the platform for producing scaffolds for growing embryonic stem cells.

15. Clauses 1-5 wherein the mycelium transformed into UNCD film provides the platform for producing scaffolds for growing embryonic cells and make them differentiate into other human cells for use in new biological treatment, replacing degraded human cells, which induce biological conditions such Parkinson, Alzheimer, and other biological deceases.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The phrase nanostructured material is intended to mean a physical substance having one or more features that are characterized by one or more dimensions less than 1 micron. The term uniformly is intended to mean unvarying or deviating very little from a given and/or expected value (e.g. within 5% of). The term substantially is intended to mean largely but not necessarily wholly that which is specified (e.g. at least 95%). The term approximately is intended to mean at least close to a given value (e.g., within 5% of). The term generally is intended to mean at least approaching a given state (e.g. at least 90%). The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials. Homologous replacements may be substituted for the substances described herein. Agents which are chemically related may be substituted for the agents described herein where the same or similar results would be achieved.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

What is claimed is:

1. A method of processing biomaterial, comprising:
providing a source of chitin; and
pyrolyzing at least a portion of the source of chitin using a microwave plasma, wherein pyrolyzing comprises
producing a nanostructured carbon material comprising at least one of diamond, ultrananocrystalline diamond, graphite, and graphene and
doping the nanostructured carbon material with at least one element selected from the group consisting of nitrogen and boron.

2. The method of claim 1, wherein pyrolyzing at least a portion of the source of chitin comprises transforming chitinous biochemical bonds to carbon sp²/sp³ bonds.

3. The method of claim 2, wherein pyrolyzing at least a portion of the source of chitin comprises converting carbon sp² graphitic bonds to carbon sp³ diamond bonds.

4. The method of claim 1, wherein the microwave plasma is formed in a reactor chamber having a process base pressure of less than 100 Tor, and an internal volume containing at least one non-oxygen process gas.

5. The method of claim 4, wherein the process base pressure is less than 10 Torr.

6. The method of claim 4, wherein the at least one non-oxygen process gas comprises argon, wherein the internal volume is substantially free of oxygen such that the at least a portion of the source of chitin is not oxidized or ashed during pyrolyzing at least a portion of the source of chitin.

7. The method of claim 6, wherein the internal volume contains a non-oxygen process gas other than argon.

8. The method of claim 1, wherein the source of chitin is derived from mycelia.

9. The method of claim 8, wherein the source of chitin is derived from chitinous cellular walls.

10. The method of claim 8, further comprising providing a source of lignin and cellulose and pyrolyzing at least a portion of the source of lignin and cellulose using the microwave plasma.

11. The method of claim 1, further comprising growing the source of chitin on an electrically conductive substrate before pyrolyzing at least the portion of the source of chitin using the microwave plasma.

12. The method of claim 11, wherein the electrically conductive substrate comprises copper.

13. The method of claim 12, wherein the electrically conductive substrate comprises graphite coated copper.

14. The method of claim 13, wherein the at least one element comprises nitrogen.

15. A composition of matter, comprising: a nanostructured carbon material comprising a network of fibers, the network of fibers being arranged in a branching root configuration,
wherein the network of fibers are comprised of at least 90% by weight of nanocarbons comprised of diamond, ultrananocrystalline diamond, graphite, graphene, and combinations thereof and
wherein the nanostructured carbon material comprises at least one dopant element selected from the group consisting of nitrogen and boron.

16. The composition of matter of claim 15, comprising carbon sp³ diamond bonds.

17. The composition of matter of claim 16, wherein the ultrananocrystalline diamond comprises a plurality of diamond grains having an average grain size of approximately 2-5 nm.

18. An article of manufacture, comprising: a nanostructured carbon material body comprising a network of fibers, the network of fibers being arranged in a branching root configuration,
wherein the network of fibers are comprised of at least 90% by weight of nanocarbons comprised of diamond, ultrananocrystalline diamond, graphite, graphene, and combinations thereof and
wherein the nanostructured carbon material comprises at least one dopant element selected from the group consisting of nitrogen and boron.

19. The article of manufacture of claim 18, wherein the nanostructured carbon material body composes a graphite coated copper electrode.

20. The article of manufacture of claim 18, wherein the nanostructured carbon material body composes a lithium ion battery.
